(19) United States
(12) Patent Application Publication
(10) Pub. No.: US 2026/0336417 A1
(43) Pub. Date: Oct. 29, 2026

(54) HIGH VOLTAGE POWER DISTRIBUTION WITH REDUNDANT ISOLATED CONNECTIONS

(71) Applicant: PACCAR Inc., Bellevue, WA (US)

(72) Inventors: Brandon Delgado, Covington, WA (US); Sam Trandem, Sammamish, WA (US); Stephen Oi, Renton, WA (US)

(21) Appl. No.: 19/188,543

(22) Filed: Apr. 24, 2025

(51) Int. Cl. B60L 3/00; B60L 1/00; B60L 50/60

(52) U.S. Cl. CPC B60L 3/0046; B60L 1/00; B60L 50/60; B60L 2210/10

(57) ABSTRACT

A high voltage distribution system for a vehicle includes a high voltage bus. The high voltage bus includes a first segment connecting battery strings with loads. The high voltage bus includes a second segment, connecting other battery strings with loads including a compressor for a braking system and/or a power steering system. The second segment can be isolated from the first segment when a fault is detected in the distribution system using an isolator. A controller can detect the fault and operate the isolator. The distribution system can be provided in a tractor or straight truck.

### BACKGROUND

Electric vehicles typically include a power distribution system, in which respective connections are made among batteries and various electrical loads included in the vehicle such that power is supplied to the various loads. Faults occurring in the power distribution system, the batteries, and/or the loads can require shutdown of the power distribution system, which can cause all connected components to lose power, including safety systems.

### SUMMARY

This disclosure is directed to power distribution systems for electric vehicles, particularly high voltage distribution systems allowing isolation of a segment of a high voltage bus.

A high voltage bus can include a segment that can be isolated. The segment that can be isolated can include one or more battery strings and safety systems for a heavy-duty electric vehicle such as a cargo vehicle (tractor-trailer, straight truck, etc.). The safety systems or components thereof can be electrically powered. Examples of such safety systems can include braking systems, for example an air braking system including an electrically powered compressor, an electrically powered power steering system, or the like. By having an isolatable segment with a limited number of battery strings and being limited to having primarily or only the safety systems as loads, it is less likely that the fault would occur in components of the isolatable segment. The isolatable segment can be isolated from the remainder of the bus in the event of a fault, thereby allowing continuity of operation for the safety systems. The safety systems can allow control of the vehicle including steering and braking, allowing the vehicle to come to a safe stop in the event a fault occurs in the power distribution system, or the batteries and/or loads connected thereto.

In an embodiment, a high voltage distribution system for a vehicle includes a high voltage bus. The high voltage bus includes a first high voltage bus segment configured to connect a first one or more battery strings with each of a first one or more loads and a second high voltage bus segment configured to connect a second one or more battery strings with each of a second one or more loads. The second one or more loads include at least one of an electrically powered braking system and an electrically powered power steering system. A connection between the first high voltage bus segment and the second high voltage bus segment includes one or more isolators operable to isolate the second high voltage bus segment from the first high voltage bus segment.

In an embodiment, a vehicle includes an electrically powered braking system, and an electrically powered power steering system. The vehicle further includes a plurality of battery strings including a first one or more battery strings and a second one or more battery strings. The vehicle also includes a high voltage distribution system including a high voltage bus. The high voltage bus includes a first high voltage bus segment configured to connect the first one or more battery strings with each of a first one or more loads and a second high voltage bus segment configured to connect the second one or more battery strings with each of a second one or more loads. The second one or more loads include at least one of the electrically powered braking system and the electrically powered power steering system. A connection between the first high voltage bus segment and the second high voltage bus segment includes one or more isolators operable to isolate the second high voltage bus segment from the first high voltage bus segment.

In an embodiment, a method for responding to a fault in a vehicle includes determining, using a controller, the presence of a fault at one or more of a high voltage distribution system, a battery, or a load included in the vehicle. When the controller determines the presence of the fault, the method further includes operating one or more isolators so as to isolate a first bus segment of the high voltage distribution system from a second bus segment of the high voltage distribution system. The first bus segment is configured to connect a first one or more battery strings with each of a first one or more loads. The second bus segment is configured to connect a second one or more battery strings with each of a second one or more loads, where the second one or more loads includes at least one of an electrically powered braking system or an electrically powered power steering system.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures:

FIG. 1 is a schematic illustration depicting a side view of a battery electric vehicle that may implement aspects of the present disclosure.

FIG. 2 illustrates a logical block diagram of a power distribution system according to an embodiment.

FIG. 3 illustrates a schematic of a power distribution system according to an embodiment.

FIG. 4 illustrates a schematic of a power distribution system according to an embodiment.

FIG. 5 illustrates a method of operating a power distribution system, according to an embodiment.

FIG. 6 is a block diagram of an example physical components of a computing device or system with which embodiments may be practiced.

### DETAILED DESCRIPTION

This disclosure is directed to power distribution systems for electric vehicles, particularly high voltage distribution systems allowing isolation of a segment of a high voltage bus.

The detailed description set forth below in connection with the appended drawings is an illustrative and non-limiting description of various embodiments of the disclosed subject matter. Wherever possible, the same reference numbers are used in the drawings and the following description to refer to the same or similar elements. In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known components or process steps have not been described in detail in order not to unnecessarily obscure various aspects of the present disclosure. Further, it will be appreciated that embodiments of the present disclosure may employ any combination of features described herein. The illustrative examples provided herein are not intended to be exhaustive or to limit the claimed subject matter to the precise forms disclosed.

While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims.

The following description proceeds with reference to examples of systems and methods suitable for use in vehicles, such as Class 8 trucks. Although illustrative embodiments of the present disclosure will be described hereinafter with reference to vehicles, it will be appreciated that aspects of the present disclosure have wide application, and therefore, may be suitable for use with many types of vehicles, such as trucks, passenger vehicles, buses, commercial vehicles, light-and medium-duty vehicles, etc.

By including safety components on a segment of the high power bus that can be isolated from other segments of the high power bus, safety-critical parts of a heavy electric vehicle, such as the power steering system and/or the braking system can maintain power and remain usable even if a significant fault occurs elsewhere in the power distribution system, batteries, or other components of the vehicle. In embodiments, only safety components and sufficient batteries to power those components are connected to the isolatable segment of the high voltage bus, thereby reducing a likelihood that a fault is occurring in the components connected to the isolatable segment of the bus. The ability to isolate the safety components from other batteries and loads advantageously allows the vehicle to be safely stopped when a fault occurs, even if the fault requires shutdown of other components or otherwise disables other vehicle systems.

As used herein, “isolated” means not electrically connected to one another through wires or any other intentional electrical connection. A component can be isolated from another component when a contactor, switch, fuse, or the like is operated to break the electrical connection between said components. As used herein, “isolate” means to make components isolated from one another, for example by operating one or more contactors, switches, fuses, combinations thereof, or the like.

As used herein, “high voltage” refers to voltages of a hazardous voltage level, for example 50 volts or higher as defined by the Occupational Safety and Health Administration. As a non-limiting example, voltages provided to and/or distributed from the high voltage distribution system discussed herein can be in a range from at or about 200 volts to at or about 1000 volts.

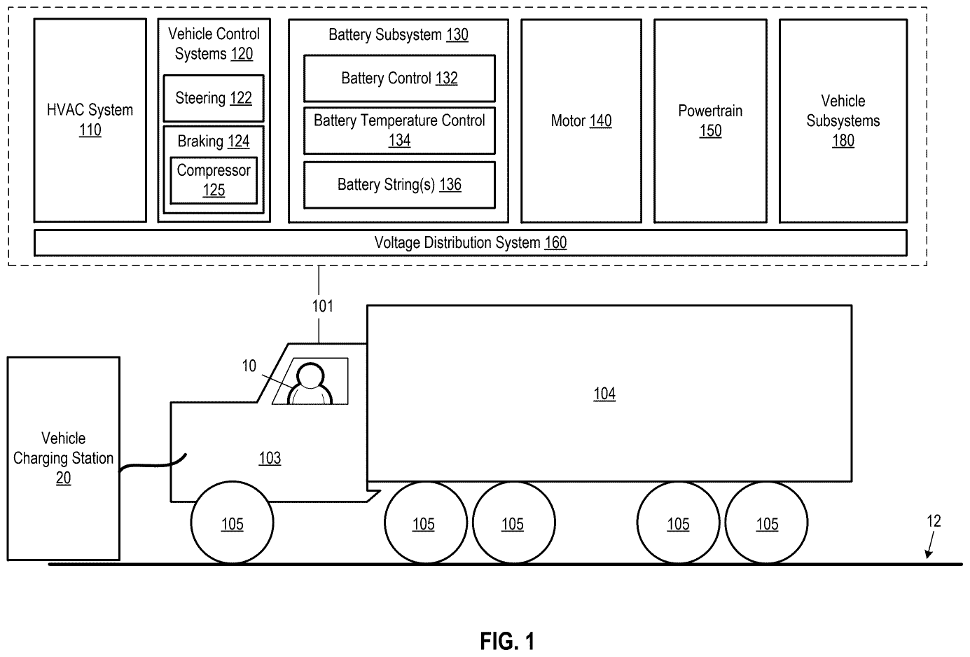

With reference now to FIG. 1, an example vehicle 101 is illustrated within which aspects of the present disclosure can be implemented. For example, FIG. 1 includes a side view 4 of the vehicle 101 further including a schematic view of various components that may be included in the vehicle 101 that may operate as part of example implementations of vehicle cabin heating. In some examples, the vehicle 101 may be a heavy-duty truck such as a part of a tractor-trailer combination. The vehicle 101 may have what is sometimes referred to as, a fifth wheel by which a box-like, flat-bed, or tanker semi-trailer 103 (among other examples) may be attached for transporting cargo or the like. While the vehicle 101 is depicted as a truck in FIG. 1, it should be appreciated that the present technology is applicable to any type of battery-electric vehicle (BEV) requiring significant battery capacity (e.g., involving multiple battery strings).

In the example shown, the vehicle 101 has a tractor portion 103 and a trailer portion 104, and is propelled on a plurality of wheels 105 on a driving surface 12. The vehicle 101 may be operated by a vehicle operator 10, who operates the vehicle from a vehicle cabin area. The vehicle cabin area is positioned within the tractor portion 103, and may include a primary vehicle cabin and/or a sleeper area. In some examples, the vehicle 101 may include a vehicle cabin HVAC system 110, a vehicle controller 120, a battery subsystem 130, a motor 140, a powertrain 150, and various other vehicle subsystems 180.

The vehicle HVAC system 110 may include various components for vehicle cabin heating and cooling, such as a vehicle cabin heater, air conditioning systems (including compressors, condensers and the like), heat pumps, and/or supplemental heating systems. The vehicle HVAC system 110 may include components positioned in the cab (e.g., under a dashboard) or inside an engine compartment of the vehicle, and is operably connected to other systems of the vehicle, such as the vehicle controller 120, as well as a coolant system useable for cooling the battery subsystem 130, motor 140, and powertrain 150.

The vehicle control system 120 may include physical and electrical components used for controlling a vehicle. For example, the vehicle control system 120 may include steering systems, critical control of braking systems, as well as a programmable circuit, such as a computing device, which may be operable to control one or more physical and/or electronic subsystems of the vehicle 101. For example, the vehicle controller 120 may include a vehicle electronic control unit (ECU), and may receive one or more sensor signals associated with the vehicle HVAC system 110, battery subsystem 130, motor 140, powertrain 150, or other vehicle subsystems 180, and may provide control signals, for example via a control bus within the vehicle, for actuating one or more subsystems in response to sensed conditions and/or user inputs. In some example embodiments, the vehicle controller 120 may perform critical operations used for safe operation and control of the vehicle, as described in further detail below. In the particular example illustrated, the vehicle controller 120 includes an electrically powered power steering system 122 and an electrically powered braking system 124.

Electrically powered power steering system 122 is a power steering system requiring electrical power to be delivered to at least one component thereof in order to function. Electrically powered power steering system 122 can be, for example, a power steering system including one or more electrically powered pumps configured to pressurize the hydraulic fluid used therein.

Electrically powered braking system 124 is a braking system requiring electrical power to be delivered to at least one component thereof in order to function. Electrically powered braking system 124 can be, for example, an air braking system including an electrically powered compressor 125 configured to provide pressurized air for operation of the air braking system.

The battery subsystem 130 includes one or more batteries that are usable to power accessory subsystems within the vehicle 101, as well as batteries used to power the motor 140 and associated powertrain 150 (e.g., in the case of the electric or plug-in hybrid electric vehicle). In some example instances, the battery subsystem 130 may include a connector configured to receive a connection from an external electrical source, such as a vehicle charging station 20. In the example shown, the battery subsystem 130 includes a battery control system 132, a battery temperature control system 134, and a plurality of battery strings 136.

The battery control system 132 communicates with the vehicle control system 120 and manages the battery strings 136 included in the battery subsystem 130. The battery control system 132 may correspond to a battery management system (B M S) used within a battery string to manage operating conditions of the battery string. The battery temperature control system 134 is connected to the battery control system 132 and battery strings 136. The battery temperature control system 134 can include components for regulating the temperature of the battery strings 136, such as coolant systems.

The battery strings 136 are groups of battery cells or batteries configured to provide power for the vehicle 101. In an embodiment, each of battery strings 136 can be configured to provide power at a suitable voltage, for example in a range from at or about 200 volts to at or about 1000 volts. The battery cells included in battery strings 136 can be, as non-limiting examples lithium-ion battery cells, nickel-metal hydride battery cells, or the like.

In some cases, the battery control system 132 battery temperature control system 134 may be partially or wholly integrated into the individualized battery strings 136, which may report on operating conditions of the battery string. This may include, as noted herein, various faults that may occur in a battery string that might require a halt in operation and servicing of the battery string.

As further described below, in typical arrangements, a heavy duty battery electric vehicle will utilize a plurality of battery strings 136 within an overall battery subsystem 130. However, inclusion of multiple battery strings increases a likelihood of failure or fault on one or more of those battery strings. As discussed below, methods and circuits for isolating critical vehicle operation and control systems are provided in which battery strings may be maintained in a connected state, but may be disconnected in the event of fault detection. This may result, for example, in disconnection of some, but not all, battery strings from the critical vehicle control systems, enabling continued operation of the vehicle in a reduced functionality state until service may be provided. This provides significant advantages to operators, since such a battery string fault may otherwise render the vehicle 101 entirely inoperable.

The motor 140 and associated powertrain 150 may operate to generate power and to convert the power into movement. For example, the motor 140 may include a power source, such as an engine, and the powertrain 150 various components that operate to convert the engine's power into movement of the vehicle (e.g. the transmission, driveshafts, differential, and axles). In some cases, the powertrain 150 may be one of various types of powertrains (e.g., diesel, hydrogen fuel cell, battery electric). In some examples, the powertrain 150 may be operable with the motor 140 to selectively operate as a generator, for example in the case of a regenerative braking arrangement. The motor 140 can be connected to the high voltage distribution system 160 so as to receive power supplied by the battery strings 136.

In particular embodiments, the battery subsystem 130 includes a high voltage battery pack and the motor includes one or more electric motors. In some instances, a motor 140 and associated powertrain 150 may be packaged within an e-axle (packaging an electric motor, power electronics, and transmission into a single unit). In such instances, one or more electric motors may be used, either in a single e-axle or across a plurality of e-axles. Additionally, one or more high voltage battery packs may be included as well.

In an example where the powertrain 150 comprises a battery electric powertrain operable with an electric motor implementing the motor 140 and battery subsystem 130 (or, in the alternative, a plug-in hybrid drivetrain that uses, in part, electrical power from battery subsystem 130 for power to the motor 140 and in part uses an internal combustion engine to drive the powertrain 150), the vehicle 101 may be operatively connectable to a vehicle charging station 20. The vehicle charging station 20 may be a home or commercial vehicle charging station capable of supplying external electrical power to the vehicle, in particular for recharging battery subsystem 130.

The vehicle 101 may include one or more other vehicle subsystems 180, such as coolant systems for regulating temperature of operating systems of the vehicle, as well as accessory power systems, lighting systems, communication systems, and various other types of equipment. Each of the other vehicle subsystems 180 may also be powered via the battery subsystem 130.

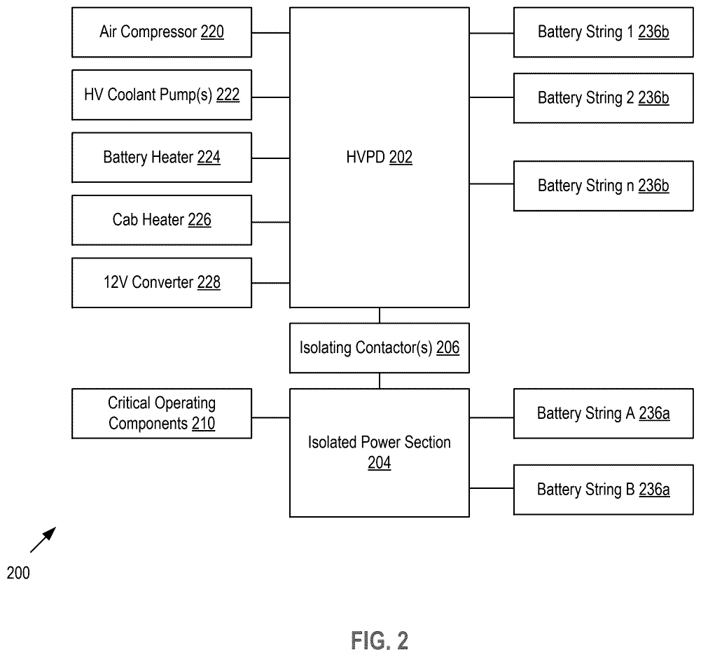

High voltage distribution system 160 is a power distribution system configured to supply power from battery strings battery subsystem 130 to high voltage loads of the vehicle 101 including but not limited to the electrically powered braking system vehicle control systems 120, including the electrically powered braking system 124, the electrically powered power steering system 122, as well as motor 140, and other electrical loads (e.g., HVAC system 110, other vehicle subsystems 180). High voltage distribution system 160 can be implemented, for example, as the high voltage distribution system as described above and shown in FIGS. 2-4, below.

Other vehicle subsystems 180 may also be connected to the voltage distribution system 160 so as to receive power therefrom. The other vehicle subsystems 180 can be any suitable electrically powered components included in the vehicle 101, with non-limiting examples including cabin HVACR loads such as HVACR systems or components thereof such as compressors, fans, and the like, cargo compartment HVACR loads, battery heating and/or cooling loads, coolant pumps, fans, DC-to-DC converters, and the like.

FIG. 2 specifically illustrates a logical block diagram of a power distribution system 200 including a high voltage power distribution (HVPD) unit 202 containing an isolated power section 204 that can be separated from other sections by isolating contactors 206. The power distribution system 200 may represent, in some embodiments, the interconnections provided by the high voltage distribution system 160 of FIG. 1 between the battery subsystem 130 and the various other components within a vehicle.

In example implementations, such as discussed below, the HVPD 202 contains fuses rated for different current levels based on connected components, voltage and current measurement equipment, and isolation detection systems that monitor for faults using resistors on positive and negative sides with switches to connect to vehicle chassis for measuring unintended current paths to ground. The system is monitored by a high voltage supervisory controller that can trigger the isolating contactors based on detected fault conditions. This allows disconnection of non-critical sections while maintaining power to safety-critical braking and steering components (included in the critical operating components 210). The isolating contactors 206 may optionally be implemented as pyrotechnic fuses rather than standard contactors, providing permanent disconnection capability that ensures isolation even under heavy load conditions where standard contactors might weld closed. The isolating contactors 206 may include both positive and negative contactors to achieve complete isolation between sections. Some contactors may include pre-charge circuits consisting of a pre-charge resistor and associated contactor in parallel with main contactor, allowing controlled charging of component capacitors to prevent damaging inrush currents.

In the example embodiment shown, the system 200 includes multiple battery strings arranged in two groups, with battery strings 1-n 236b connected to non-critical components and battery strings A-B 236a connected to safety-critical components including braking and power steering systems. The battery strings can each include their own individual contactors for isolation, though not all implementations require individual string contactors. The battery strings operate at high voltage levels, typically between 200-1000V.

In the example shown, the non-critical operating components section includes several auxiliary components such as air compressor 220, high voltage coolant pump(s) 222, battery heater 224, cab heater 226, and 12V DC-DC converter 228. These components are connected to battery strings 1-n and can be isolated in the event of a fault in those battery strings. The isolated power section 204 may include battery strings A-B, which may provide power to critical operating components 210 (e.g., electrically powered power steering and braking systems, as described above) even in the event of a fault on one of battery strings 1-n 236b.

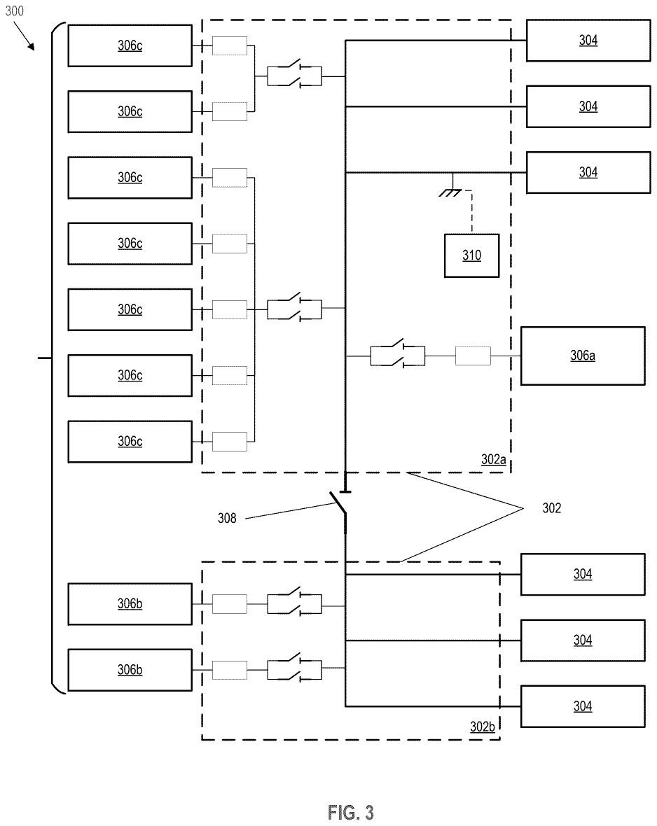

FIG. 3 illustrates a schematic of a distribution system according to an embodiment. The distribution system 300 may be used, for example, to implement the voltage distribution system 160 of FIG. 1.

In the example shown, distribution system 300 includes a high voltage bus 302, including first bus segment 302a and second bus segment 302b. Battery strings 304 are connected to the high voltage bus 302. A plurality of loads 306 including motor 306a, safety components 306b, and other loads 306c are connected to the high voltage bus 302. Isolator 308 is positioned along a connection from first bus segment 302a to second bus segment 302b. A controller 310 can further be included in distribution system 300.

Distribution system 300 is configured to allow the supply of power from battery strings 304 to the loads 306a-c of the vehicle. High voltage bus 302 provides the connections between battery strings 304 and the respective loads 306a-c. High voltage bus 302 includes a first bus segment 302a and a second bus segment 302b. In an embodiment, first bus segment 302a and second bus segment 302b can be co-located, for example in a common housing. In an embodiment, first bus segment 302a and second bus segment 302b can be located in different positions, separate housings, or the like. In an embodiment, first bus segment 302a and/or second bus segment 302b can be distributed across multiple locations, separate housings, or the like.

First bus segment 302a is a portion of the high voltage bus 302 connected to a first one or more battery strings 304, and to loads 306. The loads 306 connected to the first bus segment 302a can include the motor 306a. The loads 306 connected to the first bus segment 302a can include other loads 306c. In an embodiment, three or more of the battery strings 304 are connected to the first bus segment 302a. The connections included in first bus segment 302a can further include any suitable fuses, contactors, switches, or the like. In an embodiment, groups of loads 306 connect to respective contactors included in the first bus segment 302a. In an embodiment, a fuse is included along the connection of each of the loads 306 to the first bus segment 302a.

Second bus segment 302b is a portion of the high voltage bus 302 connected to a second one or more battery strings 304, and to loads 306. The loads 306 connected to the second bus segment 302b include the safety components 306b. In an embodiment, the only loads 306 connected to the second bus segment are the safety components 306b. In an embodiment, other loads 306c can optionally be connected to the second bus segment 302b. For example, a DC-to-DC converter can be among the loads 306 connected to second bus segment 302b. In an embodiment, three or more of the battery strings 304 are connected to the second bus segment 302b. In an embodiment, the number of battery strings 304 connected to the second bus segment 302b is selected to correspond to power requirements of the safety components 306b. For example, the number of battery strings 304 connected to second bus segment 302b can be selected to minimize the number of connected battery strings 304 beyond those that would be required to operate the safety components 306b when the second bus segment 302b is isolated from first bus segment 302a. This can reduce the likelihood that a fault occurring in distribution system 300 would be resulting from components attached to the second bus segment 302b. The connections in second bus segment 302b can include any suitable fuses, contactors, switches, or the like. In an embodiment, each of the safety components 306b can be connected to a respective contactor provided in the second bus segment 302b.

Battery strings 304 are groups of batteries or battery cells configured to supply power to the loads 306 through the high voltage bus 302. Battery strings 304 can supply power at a suitable voltage for powering the loads connected to high voltage bus 302. In an embodiment, each of battery strings 304 can be configured to provide power at a voltage in a range from at or about 200 volts to at or about 1000 volts. The groups of batteries or cells in battery strings 304 can be connected in series so as to achieve the desired input voltage for the high voltage bus 302. The battery cells included in battery strings 304 can be any suitable battery cells for powering a battery electric vehicle, for example lithium-ion battery cells, nickel-metal hydride battery cells, or the like. The battery strings 304 can include one or more battery management systems (BMS) configured to monitor the battery string or component batteries or cells thereof. The BMS can communicate with controller 310 to provide data that may be indicative of a fault in the power distribution system 300. Battery strings 304 are connected to the high voltage bus 302 so as to supply power to the loads 306 connected thereto. One or more of the battery strings 304 are connected to the first bus segment 302a, and one or more of the battery strings 304 are connected to the second bus segment 302b.

Loads 306 are various powered components of the vehicle including power distribution system 300 requiring supply of electrical power. The loads 306 can include motor 306a providing torque to drive the vehicle including power distribution system 300. Motor 306a can be any suitable traction motor for an electric vehicle. In an embodiment, multiple motors 306a can each be connected to high voltage bus 302.

Loads 306 further include safety components 306b. Safety components 306b include electrically powered components of the electric vehicle used to steer and/or stop the vehicle, such that the vehicle can be brought to a safe stop. Non-limiting examples of safety components 306 include braking systems, power steering systems, and components thereof such as compressors included in the braking systems, pumps included in power steering systems, and the like.

Other loads 306c can also be connected to the high voltage bus 302. Other loads 306c can include any electrically powered components other than the motor 306a and safety components 306b. The other loads 306c can include, for example, cabin heating, ventilation, air conditioning, and refrigeration (HVACR) loads such as HVACR systems or components thereof such as compressors, fans, and the like, cargo compartment HVACR loads, battery heating and/or cooling loads, coolant pumps, fans, DC-to-DC converters, and the like. In an embodiment, all of the other loads 306c can be connected to the first high voltage bus 302a.

Isolator 308 is provided along a line within high voltage bus 302 connecting the first bus segment 302a and the second bus segment 302b. Isolator 308 is configured to break the connection between the first bus segment 302a and the second bus segment 302b. Isolator 308 can include, as non-limiting examples, a contactor, a switch, a controllable fuse such as a pyrotechnic fuse, or the like. Isolator 308 can be configured to be operated by controller 310.

During operations where the isolator 308 has not been operated, the first bus segment 302a and the second bus segment 302b are connected to one another, such that the battery strings 304 connected to the high voltage bus 302 on either of the first bus segment 302a or the second bus segment 302b can supply power to any or all of the loads 306, including the motor 306a, safety components 306b, and other loads 306c. When isolator 308 has been operated, first bus segment 302a and second bus segment 302b are isolated from one another, such that there is no electrical connection between the loads 306 and battery strings 304 connected to the second bus segment 302b and the loads 306 and battery strings 304 connected to the first bus segment 302b. Accordingly, when the isolator 308 is operated, faults occurring in the first bus segment 302a or components connected thereto do not affect the second bus segment 302b or components connected thereto. When the isolator 308 has been operated, the first bus segment 302a and components connected thereto can be shut down without impacting the operation of the components connected to second bus segment 302b.

Controller 310 is configured to control the operation of the isolator 308. Controller 310 can be configured to receive data indicative of faults, such as data from battery management systems, data from sensors, data from the components receiving power from power distribution system 300, or the like. In an embodiment, the sensors can include resistors connected to the chassis of the vehicle to measure current leak. The controller 310 can be configured to detect the fault based on the received data, for example to determine that an isolation fault exists based on current leak data from sensors. In an embodiment, the controller 310 can characterize the fault. In an embodiment, characterizing the fault can include determining a severity of the fault, for example based on danger to the electrical systems of the vehicle, danger to persons coming in contact with the vehicle, or the like. The controller 310 can determine whether to operate the isolator 308 based on the existence of the fault, the fault being in certain categories or having a certain severity, or the like. The controller 310 can be connected to the isolator 308 such that the isolator 308 can receive a control signal from the controller, the control signal triggering the isolator 308 to operate to isolate the first bus segment 302a from the second bus segment 302b.

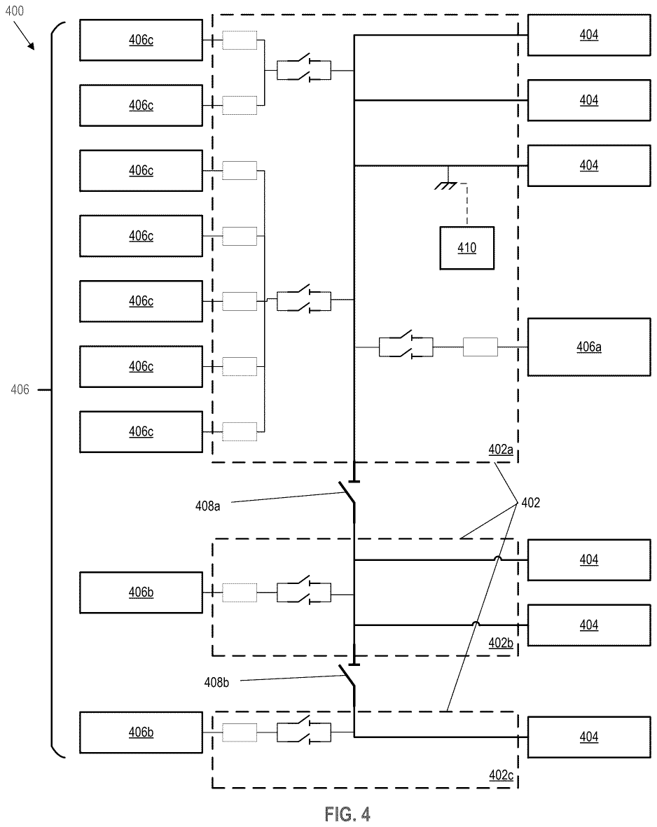

FIG. 4 illustrates a schematic of a distribution system according to an embodiment. Distribution system 400 includes a high voltage bus 402 including a first bus segment 402a, a second bus segment 402b, and a third bus segment 402c. Battery strings 404 are connected to the high voltage bus 402. A plurality of loads 406 including motor 406a, safety components 406b, and other loads 406c are connected to the high voltage bus 402. First isolator 408a is positioned between the first bus segment 402a and the second bus segment 402b. The second isolator 408b is positioned between the second bus segment 402b and the third bus segment 402c.

First bus segment 402a is connected to a first one or more battery strings 404, and to loads 406. The loads 406 connected to the first bus segment 402a can include the motor 406a. The loads 406 connected to the first bus segment 402a can include other loads 406c. In an embodiment, three or more of the battery strings 404 are connected to the first bus segment 402a. The connections included in first bus segment 402a can include any suitable fuses, contactors, switches, or the like. In an embodiment, groups of loads 406 connect to respective contactors in the first bus segment 402a.

Second bus segment 402b is connected to one or more battery strings 404 and to one of the safety components 406b. In an embodiment, second bus segment 402b is connected to sufficient battery strings 404 to power the one safety component 406b connected to second bus segment 402b. In an embodiment, the safety component 406b connected to the second bus segment 402b is an electrically powered braking system. In an embodiment, second bus segment 402b is connected to one battery string 404. The connections included in second bus segment 402b can include any suitable fuses, contactors, switches, or the like. In an embodiment, a contactor can be provided along the connection of the safety component 406b to the second bus segment 402b. Second bus segment 402b can be isolated from the first bus segment 402a by operation of the first isolator 408a. Second bus segment 402b can be isolated from the third bus segment 402a by operation of the second isolator 408b.

Third bus segment 402c is connected to one or more battery strings 404 and to one of the safety components 406b. In an embodiment, third bus segment 402c is connected to sufficient battery strings 404 to power the one safety component 406b connected to third bus segment 402c. In an embodiment, the safety component 406b connected to the third bus segment 402c is an electrically powered power steering system. In an embodiment, third bus segment 402c is connected to one battery string 404. The connections included in third bus segment 402c can include any suitable fuses, contactors, switches, or the like. In an embodiment, a contactor can be provided along the connection of the safety component 406b to the third bus segment 402c. Third bus segment 402c can be isolated from both of the first bus segment 402a and the second bus segment 402b by operation of the second isolator 408b.

Battery strings 404 are groups of battery cells or batteries configured to supply power to the loads 406 through the high voltage bus 402. Battery strings 404 can supply power at a suitable voltage for powering the loads connected to high voltage bus 402. In an embodiment, each of battery strings 404 can be configured to provide power at a voltage in a range from at or about 200 volts to at or about 1000 volts. The groups of batteries or cells in battery strings 404 can be connected in series so as to achieve the desired input voltage for the high voltage bus 402. The battery cells included in battery strings 404 can be any suitable battery cells for powering a battery electric vehicle, for example lithium-ion battery cells, nickel-metal hydride battery cells, or the like. The battery strings 404 can include one or more battery management systems (BMS) configured to monitor the battery string or component batteries or cells thereof. The BMS can communicate with controller 410 to provide data that may be indicative of a fault in the power distribution system 400. Battery strings 404 are connected to the high voltage bus 402 so as to supply power to the loads 406 connected thereto. One or more of the battery strings 404 are connected to the first bus segment 402a, one or more of the battery strings 404 are connected to the second bus segment 402b, and one or more of the battery strings 404 are connected to the third bus segment 402c.

Loads 406 are various powered components of the vehicle including power distribution system 400 requiring supply of electrical power. The loads 406 can include motor 406a, safety components 406b, and other loads 406c. The motor 406a can include one or more electric motors providing torque to drive the vehicle including power distribution system 400. Safety components 406b can include electrically powered components of the electric vehicle used to steer and/or stop the vehicle, such that the vehicle can be brough to a safe stop, for example electrically powered power steering systems or components thereof, an electrically powered braking system, or the like. Other loads 406c can include any electrically powered components of the vehicle other than the motor 406a and safety components 406b.

Isolators 408a,b are provided between the respective segments of the high voltage bus 402. For example, as shown in FIG. 4, first isolator 408a is positioned between the first bus segment 402a and the second bus segment 402b, and second isolator 408b is positioned between the second bus segment 402b and the third bus segment 402c. In embodiments including additional segments in the high voltage bus 402, further isolators can be included between each adjacent segment. Each of isolators 4a,b can be, as non-limiting examples, a contactor, a switch, a controllable fuse such as a pyrotechnic fuse, or the like. In the embodiment shown in FIG. 4, when first isolator 408a is operated, the second and third bus segments 402b,c are isolated from first bus segment 402a. When the second isolator 408b is operated, the third bus segment 402c is isolated from first bus segment 402a and second bus segment 402b. Isolators 408a,b can be configured to be operated by controller 410, for example based on detection of a fault in the high voltage bus 402 or components connected thereto, the fault being of sufficient severity, or the like.

Controller 410 is configured to control the operation of the isolators 408a,b. Controller 410 can be configured to receive data indicative of faults, such as data from battery management systems, data from sensors, data from the components receiving power from power distribution system 400, or the like. In an embodiment, the sensors can include resistors connected to the chassis of the vehicle to measure current leak. The controller 410 can be configured to detect the fault based on the received data, for example to determine that an isolation fault exists based on current leak data from sensors. In an embodiment, the controller 410 can characterize the fault. In an embodiment, characterizing the fault can include determining a severity of the fault, for example based on danger to the electrical systems of the vehicle, danger to persons coming in contact with the vehicle, or the like. Based on the detection and/or characterization of the fault, the controller 410 can determine whether to operate the isolators 408a,b. In an embodiment, the controller 410 is configured to operate all of the isolators 408a,b together. For example, when the controller 410 determines a fault is present and the isolators 408a,b are to be operated, the controller 410 can issue a command directing each of the isolators 408a,b in the power distribution system 400 to be operated. In an embodiment, the controller 410 is configured to operate each isolator 408a,b independently. For example, the controller 410 may determine separately whether to operate first isolator 408a to isolate second and third bus segment 402b,c from first bus segment 402a, whether to operate second isolator 408b to isolate the third bus segment 402c from first and second bus segments 402a,b, or both.

In the embodiment shown in FIG. 4, each of the safety components 406b is provided in a respective bus segment 402b,c that can be isolated from other segments of the high voltage bus 402 by operation of the respective isolator 408a,b. While FIG. 4 shows two such safety components 406b, any number of such safety components 406b can be included as loads of the distribution system 400, with each safety component 406b being connected to a respective segment of the high voltage bus 402 capable of being isolated from other segments of the high voltage bus 402 by operation of one or more of the isolators 408.

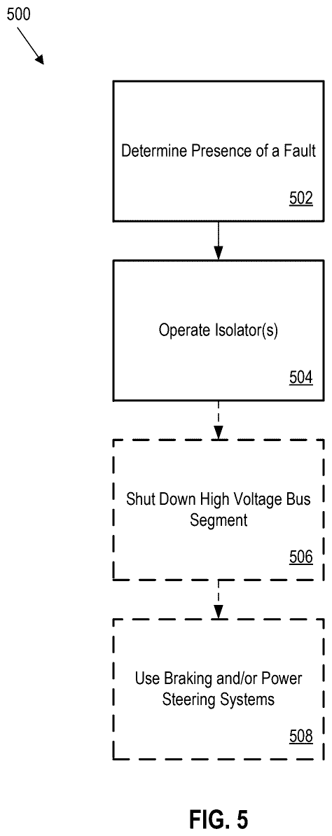

FIG. 5 illustrates a method according to an embodiment. Method 400 includes determining a presence of a fault 502 and operating an isolator 404. Method 400 can be performed on a high voltage distribution system, such as a high voltage distribution system of a vehicle. Method 500 can optionally further include shutting down a segment of a high voltage bus. Method 500 can optionally further include operating one or more of a power steering system or a braking system of the vehicle.

In the example shown, the method 500 may include determining a presence of a fault (step 502). The presence of the fault can be determined at a controller, for example controller 120 described above and shown in FIG. 1, or controller 310 of FIG. 3. The presence of the fault can be determined based on any suitable inputs received at the controller, for example data from one or more battery management systems, data from one or more sensors such as current leak sensors connected to a chassis of the vehicle, data from one or more of the loads connected to the power distribution system, combinations thereof, and the like. In an embodiment, the fault can additionally be characterized and/or a severity of the fault can be determined.

When the fault is determined to be present at step 502, at least one isolator can be operated (step 504). The isolator can be, for example, the isolator 206 of FIG. 2, isolated 308 of FIG. 3, or one or more of isolators 408a,b as described above and shown in FIG. 4, respectively, or the like. The operation of the isolator at step 504 can isolate a segment of the high voltage bus of the high voltage distribution system including safety components and sufficient battery strings to support operation of the safety components from other segments of the high voltage bus. The isolation of the segment of the high voltage bus including the safety components allows the safety components to continue to be powered despite the fault, or actions taken in response thereto. The isolator can be operated according to the type of isolator being used, such as opening of switches or contactors, severing a connection in a fuse, for example by triggering a pyrotechnic fuse, or the like. In an embodiment, the operation of the isolator can be based on a severity of the fault determined to be occurring at step 402. For example, the operation of the isolator can be performed when the fault is of sufficient severity to require shutdown of the high voltage bus, presents significant risk to personnel, when the fault can potentially disrupt the operation of the safety components connected to a segment of the high voltage bus, or the like.

Optionally, following operation of the isolator(s), one or more segments of the high voltage bus and/or one or more components connected thereto can be shut down (step 506). The segment(s) of the high voltage bus that are shut down can include one or more segments of the high voltage bus that do not connect to safety components, for example the first high voltage bus segment 302a described above and shown in FIG. 3.

Optionally, following operation of the isolator(s), one or more of a power steering system or a braking system of the vehicle can be operated (step 508). In an embodiment, the operation of the power steering system or the braking system can be performed following shutdown of the segment of the high voltage bus or components connected thereto. The power steering system and/or the braking system can continue to receive power by way of the isolated segment of the high voltage bus, such as the second bus segment 102b as described above and shown in FIG. 1. The power steering system and/or the braking system can be operated to allow the vehicle to be safely brought to a stop in a suitable area, for example pulling over onto a shoulder and coming to a complete stop. When stopped, the vehicle can await service to address the fault determined at step 502.

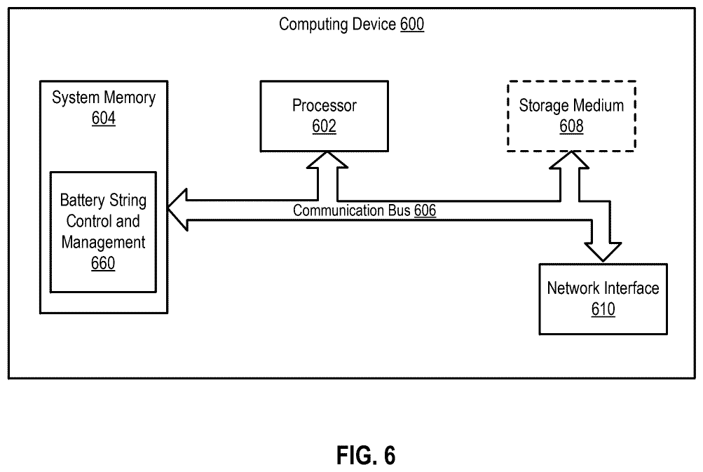

FIG. 6 is a block diagram of an illustrative computing device 600 appropriate for use in accordance with embodiments of the present disclosure. The description below is applicable to the vehicle controller 120, servers, personal computers, mobile phones, smart phones, tablet computers, embedded computing devices, and other currently available or yet-to-be-developed devices that may be used in accordance with embodiments of the present disclosure.

In its most basic configuration, the computing device 600 includes at least one processor 602 and a system memory 604 connected by a communication bus 606. Depending on the exact configuration and type of device, the system memory 604 may be volatile or nonvolatile memory, such as read-only memory (“ROM”), random access memory (“RAM”), EEPROM, flash memory, or other memory technology. Those of ordinary skill in the art and others will recognize that system memory 604 typically stores data or program modules that are immediately accessible to or currently being operated on by the processor 602. In this regard, the processor 602 may serve as a computational center of the computing device 600 by supporting the execution of instructions. According to one example, the system memory 604 may store instructions for control or actuation of voltage distribution systems, such as the voltage distribution system 160 of FIG. 1 (e.g., via battery string control and management instructions 660, which may be executed by control systems 120, 310 as described above).

As further illustrated in FIG. 6, the computing device 600 may include a network interface 610 comprising one or more components for communicating with other devices over a network. Embodiments of the present disclosure may access basic services that utilize the network interface 610 to perform communications using common network protocols. The network interface 610 may also include a wireless network interface configured to communicate via one or more wireless communication protocols, such as WiFi, 2G, 3G, 4G, 5G, LTE, WiMAX, Bluetooth, or the like.

In the illustrative embodiment depicted in FIG. 6, the computing device 600 also includes a storage medium 608. However, services may be accessed using a computing device that does not include means for persisting data to a local storage medium. Therefore, the storage medium 608 depicted in FIG. 6 is optional. In any event, the storage medium 608 may be volatile or nonvolatile, removable or non-removable, implemented using any technology capable of storing information such as, but not limited to, a hard drive, solid state drive, CD ROM, DVD, or other magnetic and/or optical disk storage.

As used herein, the term “computer-readable medium” includes volatile and nonvolatile and removable and non-removable media implemented in any method or technology capable of storing information, such as computer-readable instructions, data structures, program modules, or other data. In this regard, the system memory 604 and storage medium 608 depicted in FIG. 6 are examples of computer-readable media.

For ease of illustration, FIG. 6 does not show some of the typical components of many computing devices. In this regard, the computing device 600 may include input devices, such as a keyboard, keypad, mouse, trackball, microphone, video camera, touchpad, touchscreen, electronic pen, stylus, or the like. Such input devices may be coupled to the computing device 600 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 600 (e.g., a client device), or can be integral components of the computing device 600. In some embodiments, multiple input devices may be combined into a single, multifunction input device (e.g., a video camera with an integrated microphone). The computing device 600 may also include output devices such as a display, speakers, printer, etc. The output devices may include video output devices such as a display or touchscreen. The output devices also may include audio output devices such as external speakers or earphones. The output devices can be separate from and communicatively coupled to the computing device 600, or can be integral components of the computing device 600. Input functionality and output functionality may be integrated into the same input/output device (e.g., a touchscreen). Any suitable input device, output device, or combined input/output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, HTML, CSS, Javascript, PythonScript, VB Script, A SPX, Microsoft . NETTM languages such as C#, or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

1. A high voltage distribution system for a vehicle, comprising:
a high voltage bus including:
a first high voltage bus segment configured to connect a first one or more battery strings with each of a first one or more loads; and
a second high voltage bus segment configured to connect a second one or more battery strings with each of a second one or more loads, the second one or more loads including at least one of an electrically powered braking system and an electrically powered power steering system,
wherein a connection between the first high voltage bus segment and the second high voltage bus segment includes one or more isolators operable to isolate the second high voltage bus segment from the first high voltage bus segment.

2. The system of claim 1, wherein the second one or more loads consists of the electrically powered braking system and the electrically powered power steering system.

3. The system of claim 1, wherein the high voltage bus further comprises a third high voltage bus segment configured to connect a third one or more battery strings with a third one or more loads including the electrically powered power steering system, wherein the second one or more loads includes the electrically powered braking system, wherein the third high voltage bus segment is connected to one or both of the first high voltage bus segment or the second high voltage bus segment by a connection including one or more isolating contactors.

4. The system of claim 3, wherein the second one or more loads consists of the electrically powered braking system, and the third one or more loads consists of the electrically powered power steering system.

5. The system of claim 1, wherein the first one or more loads includes a motor of the vehicle.

6. The system of claim 1, wherein the second one or more loads further includes a DC-to-DC converter.

7. The system of claim 1, further comprising a controller, the controller configured to determine the presence of a fault in the high voltage distribution system, and when the fault is determined to be present, operating the one or more isolators to isolate the second high voltage bus segment from the first high voltage bus segment.

8. The system of claim 1, wherein the one or more isolators include a contactor.

9. The system of claim 1, the one or more isolators include a pyrotechnic fuse.

10. A vehicle, comprising:
an electrically powered braking system;
an electrically powered power steering system;
a plurality of battery strings including a first one or more battery strings, and a second one or more battery strings; and
a high voltage distribution system including a high voltage bus, the high voltage bus including:
a first high voltage bus segment configured to connect the first one or more battery strings with each of a first one or more loads; and
a second high voltage bus segment configured to connect the second one or more battery strings with each of a second one or more loads, the second one or more loads including at least one of the electrically powered braking system or the electrically powered power steering system,
wherein a connection between the first high voltage bus segment and the second high voltage bus segment includes one or more isolators operable to isolate the second high voltage bus segment from the first high voltage bus segment.

11. The vehicle of claim 10, wherein the second one or more loads consists of the electrically powered braking system and the electrically powered power steering system.

12. The vehicle of claim 10, wherein the high voltage bus further comprises a third high voltage bus segment configured to connect a third one or more battery strings with a third one or more loads including the electrically powered power steering system, wherein the second one or more loads includes the electrically powered braking system, wherein the third high voltage bus segment is connected to one or both of the first high voltage bus segment and the second high voltage bus segment by a connection including one or more isolators.

13. The vehicle of claim 12, wherein the second one or more loads includes the electrically powered braking system, and the third one or more loads consists of the electrically powered power steering system.

14. The vehicle of claim 10, wherein the first one or more loads includes a motor of the vehicle.

15. The vehicle of claim 10, wherein the second one or more loads further includes a DC-to-DC converter.

16. The vehicle of claim 10, further comprising a controller, the controller configured to determine the presence of a fault in the high voltage distribution system, and when the fault is determined to be present, operating the one or more isolators to isolate the second high voltage bus segment from the first high voltage bus segment.

17. The vehicle of claim 10, wherein the one or more isolators include a contactor.

18. The vehicle of claim 10, wherein the one or more isolators include a pyrotechnic fuse.

19. The vehicle of claim 10, wherein the vehicle is a tractor or a straight truck.

20. A method for responding to a fault in a vehicle, comprising:
determining, using a controller, the presence of a fault at one or more of a high voltage distribution system, a battery, or a load included in the vehicle; and
when the controller determines the presence of the fault, operating one or more isolators so as to isolate a first bus segment of the high voltage distribution system from a second bus segment of the high voltage distribution system, wherein:
the first bus segment is configured to connect a first one or more battery strings with each of a first one or more loads, and
the second bus segment is configured to connect a second one or more battery strings with each of a second one or more loads, and
the second one or more loads includes at least one of an electrically powered braking system or an electrically powered power steering system.
